(19) United States
(12) Patent Application Publication
(10) Pub. No.: US 2012/0179909 A1
(43) Pub. Date: Jul. 12, 2012

(54) SYSTEMS AND METHODS FOR PROVIDING INDIVIDUAL ELECTRONIC DOCUMENT SECURE STORAGE, RETRIEVAL AND USE

(75) Inventors: Surya R. Sagi, Southbury, CT (US); Frederick W. Ryan, JR., Oxford, CT (US); Bernard E. Gracy, Southbury, CT (US)

(73) Assignee: PITNEY BOWES INC., Stamford, CT (US)

(21) Appl. No.: 13/341,959

(22) Filed: Dec. 31, 2011

Related U.S. Application Data
(60) Provisional application No. 61/430,513, filed on Jan. 6, 2011.

(51) Int. Cl. H04L 29/06

(52) U.S. Cl. 713/167

(57) ABSTRACT

Systems and methods for providing secure digital mail document storage, retrieval and use in a cloud computing environment, such as by advantageously configuring a hybrid cloud computing environment are described. In one, a privately hosted data processing system includes a private key and a PKI decryption subsystem, and a publicly hosted data processing system includes a symmetric key decryption subsystem, wherein digital documents are encrypted by a corresponding individual symmetric key and each of the symmetric keys is encrypted by a public key associated with the private key. In another configuration, document decryption is handled differently depending upon the type of client making the request.

### CROSS REFERENCE TO RELATED APPLICATIONS

This application claims priority under 35 U.S.C. section 119(e) from Provisional Patent Application Ser. No. 61/430,513, filed Jan. 6, 2011, entitled Systems and Methods for Providing Individual Electronic Document Secure Storage, Retrieval and Use (Attorney Docket G-578), by Surya R. Sagi, et al., which is incorporated herein by reference in its entirety.

### TECHNICAL FIELD

The illustrative embodiments of the present application relate generally to secure document delivery systems and, more particularly, to new and useful systems and methods for secure digital mail document storage, retrieval and use in a cloud computing environment.

### BACKGROUND

In the United States, many people are utilizing electronic access to financial and other transactional accounts. Additionally, there has been significant adoption of electronic bill payment in recent years, with electronic payment now outpacing payment by putting a check in the mail. However, many people prefer to continue to receive physical delivery of paper statements.

Systems and methods have been described for using a physical mailing address as an electronic mail address. For example, U.S. Pat. No. 7,478,140, entitled System and Method for Sending Electronic Mail and Parcel Delivery Notification Using Recipient's Identification Information, issued Jan. 13, 2009 to King, et al. describes a system using a recipient's physical address.

An electronic digital mail system that is intended to service a large nation will require a significant amount of computing resources. Additionally, the resource needs of such a system will change over time. Current systems do not provide an optimal solution in terms of privacy, cost and scalability. For example, completely privately hosted internal computing systems may be costly and may involve significant capital expenditures before the computing resources are actually needed. Moreover, privately hosted computing environments and associated deployed systems may take longer to deploy and longer to scale to larger capabilities. Additionally, privately hosted systems may entail relatively high maintenance costs compared to other architectures and may provide relatively less resiliency and redundancy than with alternative architectures. However, one relatively inexpensive architecture known as the public cloud, at least in many implementations suffers from several drawbacks such as having concerns about security and privacy. Moreover many such hosting systems do not adequately provide services that consider different client types when responding to a particular request for a secure digital document.

Accordingly, there is a need, among other needs, for systems and methods to provide secure digital mail document storage, retrieval and use in a cloud computing environment. Furthermore, there is a need, among other needs, for a hosting system that adequately provides services that consider different client types.

### BRIEF DESCRIPTION OF THE DRAWINGS

The accompanying drawings show illustrative embodiments of the invention and, together with the general description given above and the detailed description given below serve to explain certain principles of the invention. As shown throughout the drawings, like reference numerals designate like or corresponding parts.

FIG. 1 is a schematic diagram showing a system for providing secure digital mail document storage, retrieval and use in a cloud computing environment according to an illustrative embodiment of the present application.

FIG. 2 is a schematic diagram showing an automated document factory for providing secure mail information according to an illustrative embodiment of the present application.

FIG. 3 is a schematic diagram showing a secure mail system according to an illustrative embodiment of the present application.

FIG. 4 is a schematic diagram showing a secure mail system according to an illustrative embodiment of the present application.

FIG. 5 is a diagram showing a data flow for providing secure digital mail document storage, retrieval and use in a cloud computing environment according to an illustrative embodiment of the present application.

FIG. 6A is a schematic diagram showing a secure mail system according to an illustrative embodiment of the present application.

FIG. 6B is a schematic diagram showing a secure mail system according to an illustrative embodiment of the present application.

FIG. 7 is a flowchart diagram showing a process for decrypting secure mail documents based upon client type according to an illustrative embodiment of the present application.

FIG. 8 is a schematic diagram showing a cloud platform for use in a mail system according to an illustrative embodiment of the present application.

FIG. 9 is a flowchart diagram showing a process for encrypting secure mail documents according to an illustrative embodiment of the present application.

FIG. 10 is a flowchart diagram showing a process for decrypting secure mail documents based upon client type according to an illustrative embodiment of the present application.

### SUMMARY

Illustrative systems and methods for providing secure digital mail document storage, retrieval and use in a cloud computing environment, such as by advantageously configuring a hybrid cloud computing environment are provided. In at least certain embodiments, a hosting system provides services such as selective decryption services based upon the type of client making the request.

In at least certain illustrative embodiments, a system for cryptographically securing a plurality of digital documents includes a first data processing system that is privately hosted, the first data processing system including at least one private key and a PKI decryption subsystem, and a second data processing system that is in a public shared hosted environment, the first data processing system including a symmetric key decryption subsystem, and memory storage for storing each of the plurality of digital documents and a corresponding symmetric key, wherein each of the plurality of digital documents is encrypted by the corresponding symmetric key and each of the corresponding symmetric key is encrypted by a public key corresponding to the at least one private key, wherein the second data processing system includes a second virtual processor and memory for executing instructions including, sending the encrypted symmetric key to the first data processing system using a secure communications channel, and the first data processing system includes a first processor and memory for executing instructions including, decrypting the symmetric key using the at least one private key and returning the decrypted symmetric key to the second data processing system.

In at least certain additional embodiments, the first data processing system includes a private cloud computer processing system, and the second data processing system includes a public cloud computer processing system, the second processing system memory storage further stores a corresponding thumbnail for each of the plurality of digital documents and wherein each thumbnail is also encrypted by the corresponding symmetric key associated with the corresponding digital document.

In at least certain additional embodiments, the at least one private key includes at least two private keys, and the first data processing system includes a first processor and memory for executing further instructions including, determining an appropriate one private key of the at least two private keys, and decrypting the symmetric key using the appropriate one private key, wherein, determining an appropriate one private key of the at least two private keys includes utilizing a geographic identifier.

In at least certain embodiments, a computer implemented method for processing a request from a client for a secure digital document based upon client type, the secure digital documented encrypted by a first key and the first key encrypted by a second key, the method including determining a type of client making the request, and, if the determined type of client is a first type, then decrypting the second key and sending the decrypted second key and the encrypted digital document to the client, and if the determined type of client is a second type, different from the first type, then decrypting the second key, decrypting the first key using the second key, decrypting the digital document using the first key and sending the decrypted digital document to the client.

In at least certain additional embodiments, the first type is selected from a group consisting of a mobile application, a heavy client and a browser with a plug-in associated with the process, the second type is a browser without a plug-in associated with the process, the first key is a symmetric key and the second key is an asymmetric key.

In at least certain additional embodiments, if the determined type of client is the first type, then responding to the request using a first virtual machine, and if the determined type of client is the second type, then responding to the request using a second type of virtual machine, different from the first virtual machine.

Several additional alternatives are disclosed and described herein.

### DETAILED DESCRIPTION

The present invention is described in the context of illustrative embodiments directed to new and useful systems and methods for providing secure digital mail document storage, retrieval and use in a cloud computing environment, such as by advantageously configuring a hybrid cloud computing environment. In at least certain embodiments, a hosting system provides services such as selective decryption services based upon the type of client making the request.

Several illustrative embodiments described herein refer interchangeably to the VOLLY secure digital delivery service, digital mailbox system (DMB) or Digital Mail Platform (DMP). The illustrative system provides a closed, secure, end-to-end system that consolidates and digitally delivers items, also called mail pieces, such as mail, transaction statements, marketing promotions, catalogs and other rich media from businesses to consumers. This delivery may be based upon the recipient's (user, consumer) physical street address. The illustrative embodiments provide a novel consumer experience, allowing customers to help manage their lifestyles with greater convenience and control. This new communications channel provides benefits to mailers including by providing a low-cost yet trusted and secure electronic distribution platform, with minimal expense in switching from existing mailing processes including physical mailing processes. Moreover, mailers (senders, billers, etc.) are provided the opportunity to provide electronic metadata such rich time-sensitive data to the recipients, even if the mail pieces are delivered physically.

Consumers are provided several benefits including the ability to aggregate mail digitally from multiple providers, to enjoy secure remote access from a single log-in, and to choose from a wealth of options for sorting, prioritizing, processing, paying, archiving, retrieving, discarding and reporting on all their mail-based activities across numerous electronic client platforms including smart phones, tablets, laptop computers, desktop computers and other network capable computing devices. Moreover, the consumers are provided enhanced management and scheduling tools to aggregate time-sensitive data for mail pieces received electronically, by physical mail and/or by user uploading of documents into the system such as for secure storage and record keeping. Additionally, it may offer consumers opt-in control over how they will be marketed and communicated to, and in what format. Here, an illustrative calendar based system for organizing reminders and notices as well as facilitating follow-on actions related to digital documents including mail, transaction statements, marketing promotions, catalogs and rich media is described. Mail pieces herein can refer to letters, bills, statements, postcards, flyers, offers, catalogs and other types of mail that are commonly received.

Several illustrative hardware and software systems and subsystems are described herein that may be implemented using one or more alternative architectures. Here, in an alternative applicable to any of the embodiments the system is implemented on a cloud based platform using Infrastructure as Service (IaaS) architecture for processing and storage such as the RACKSPACE CLOUD, and TERREMARK ECLOUD platform or the AMAZON EC2 platform. Alternatively, the systems, processes and storage functions described may be implemented using other hosting architectures such as in-house, dedicated hosting, shared hosting or some other hosting model. As a further alternative, the MICROSOFT AZURE platform may be utilized.

Several illustrative hardware and software systems and subsystems are described herein that may advantageously utilize certain available components. For example, automated document factories having many configurations may be purchased from Pitney Bowes Inc. located in Stamford, Conn. Similarly, certain print-to-mail systems are available from the Pitney Bowes Emtex and Pitney Bowes Business Insight subsidiaries of Pitney Bowes Inc. located in Stamford, Conn. Systems herein may utilize print stream processing systems, document printing, insertion and franking systems and electronic bill presentment and payment (EBPP) systems available from Pitney Bowes Inc. The servers described are typically INTEL architecture servers such as DELL servers using the WINDOWS SERVER operating system software and the databases utilize APACHE CASSANDRA database systems. Alternatively, ORACLE database systems may be utilized. Additionally, the illustrative embodiments are described as enhancements to previously commercially available software systems marketed by EMTEX available from Pitney Bowes Inc. of Stamford, Conn.

Additionally, certain outgoing mail print stream processing systems have been described for separating documents in a print stream or batch into two separate print streams—a physical delivery print stream and an electronic delivery print stream based on customer delivery preferences. Commonly-owned U.S. Pat. No. 6,343,327, entitled System and Method for Electronic and Physical Mass Mailing, issued to Daniels, Jr., et al. on Jan. 29, 2002 describes such systems and is incorporated by reference herein in its entirety. Such systems described therein may be modified using the systems, processes and techniques described herein to provide an initial delivery channel with a backup channel that is used when deemed necessary.

Mail pieces such as variable data documents that are printed and mailed (i.e. statements, invoices, targeted marketing communications) often contain sensitive information. It is essential for document owners (senders) to ensure relatively secure delivery of these documents to their customers and to provide relatively secure storage of such documents.

In one illustrative embodiment, a secure document storage system is provided that provides individual document encryption security as stored using individual keys and in certain cases provides such individual document security during transport through an encrypted communications channel tunnel. A secure key management protocol is provided to enable use of public cloud storage and backup without risk of exposing the contents of documents. A novel public/private cloud key management and encryption system provides encryption security at a document level, but may also be used to efficiently distribute encryption computing requirements in a beneficial manner.

In certain illustrative embodiments, the DMB uses security with public/private key infrastructure (PKI) for all or groups of keys and uses symmetric key encryption with a separate key for each document or document/thumbnail/metadata set. For example, in one configuration, the PKI implementation uses RSA 2048 bit keys and the symmetric key implementation uses AES with 256 bit keys. In certain configurations, a hybrid cloud architecture is utilized that has public shared cloud-based infrastructure components in a configuration that may be called a virtualized, closed, private network.

In certain configurations, the system implements role-based access and Federated Access Control using industry standards (SAML 2.0) and implements a PCI compliant payment system. Similarly, in certain configurations, the embodiments provide multilevel authentication for users/consumers with passwords, random security questions, site keys and secret phrases. The system may also centralize mailer-level authentication with role-based access to mailer users. Certain embodiments provide encryption of all personally identifiable information (PII), strong one-way encryption of log-in credentials, automatic account log-out after a period of inactivity, security image to prevent phishing attacks, additional security questions, system-generated alerts and notifications for increased security, secure data storage in a separate database protected with hardware and software encryption techniques, protection of every customer statement and bill using a unique key protected by a hardware security module, automatic backup of database servers for added data protection and user control over who can deliver mail to the account. Trust seals from TRUSTE and VERISIGN may be used.

In certain embodiments data security is provided such that all PCI and HIPAA compliant data fields encrypted/masked in the data store, file system and messaging queues, and during data transfer across networks. Certain embodiments employ a services-oriented architecture. Such consumer services are developed using REST and such mailer services are developed using SOAP/WSDL. The services use token-based authentication and authorization mechanisms to make sure that only valid, authenticated systems/processes can communicate with the DMB platform. Certain embodiments utilize a Secure Sockets Layer (SSL) Certificate-based public access scheme. The public interface uses trust seals providing the user with the level of trust meant for a payment site as well as ensuring that privacy is completely covered.

Certain embodiments rely on a physical address for delivery. The DMB service uses certified addresses to verify address accuracy during customer on-boarding. DMB capabilities automatically pair the street address of the bill or statement with the digital mailbox address during the production run in an automated document factory. T service keeps track of address changes and moves for consumers and handles the delivery of mail to the current address. This ensures that mail will not be delivered to the wrong address when a consumer moves, protecting privacy and also reducing mailer liability. The DMB service may also geocode each address for further verification.

The DMB platform ensures that only the owner of the document has access to the document. The document itself is encrypted and stored by an AES 256-bit security mechanism, where the signing key is itself encrypted using public/private key infrastructure. The public/private keys are stored in a hardware security module. This module is typically used for very high-security applications. The document encryption happens at the document production site, so effectively the document is encrypted at the source and is opened only at the destination. This also signifies that the document's rest state throughout the DMB engagement is both encrypted and secured. The DMB document retrieval process passes through an application-level check to authorize the user, for which the user's credentials are provided and validated against the secure SSO framework.

In certain embodiments, a Secure Mailer Gateway (SMG) is installed at the service provider mailer site and connects to the DMB service using a secure VPN. This ensures that all data being transferred from the mailer to the DMB service is secure and encrypted in the transfer mode. The decision for electronic/physical split is handled at the mailer site based on delivery preference lookup using the mailing address data extracted from statements during the production run. The Secure Mailer Gateway also ensures that all electronic documents are individually encrypted at the mailer site prior to transmission. The system also offers PCI compliant payment capability for billing statements using ACH (Automated Clearing House) and credit cards. All the payment account data is encrypted and stored in a private database. In order to facilitate payments, the payment-centric details are extracted from statements during the production run. The system also uses a role-based access protocol whereby every user including consumers and mailers is assigned a role that decides the operation/functionality a user can access. The role-based access protocol is built using an authorization component of Single Sign On (SSO) and uses secure LDAP as the underlying data store. All access points including service endpoints and user interfaces are controlled by this role-based access system. Every change made to this access control system is logged for security audits.

In certain embodiments, DMB access is provided to all consumers, whether Web-based or through mobile devices, via industry standard HTTPS (HTTP over 128-bit SSL) encryption. In the system, consumers are on-boarded using a secure registration form, with authentication and authorization handled using SSO. The SSO internally uses a very secure LDAP-based data store that maintains password encryption. The DMB service uses a strong CAPTCHA mechanism to protect against automated attacks. Address verification, e-mail verification and identity verification help to ensure that all consumers are validated and that they are the actual residents at the designated street address before they become operational users. This means that the mailer does not have to manage email identity. Site keys and security questions further provide a secure way of validating and managing users. All consumer access to the DMB service is logged and audited for possible resolution of security issues. The unique address sanitization process helps ensure that mailers can use the DMB service with high confidence.

Several additional illustrative embodiments of digital mailbox system designs are now described with reference to the figures that may be implemented for use alone or in various combinations with any of the alternative components and embodiments herein.

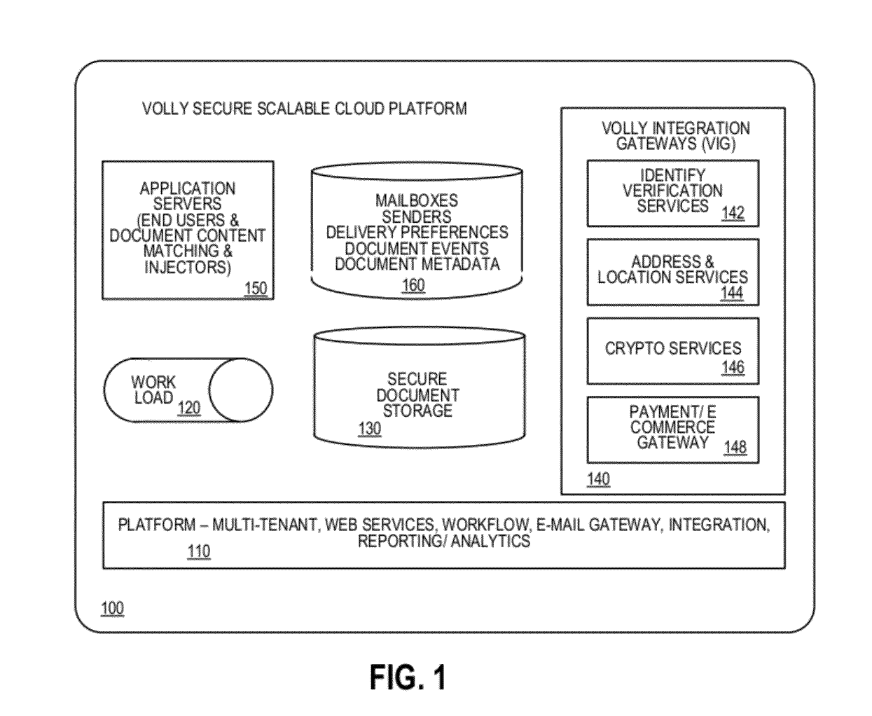

Referring to FIG. 1, a schematic diagram showing a system 100 for providing secure digital mail document storage, retrieval and use in a cloud computing environment according to an illustrative embodiment of the present application is disclosed. In this illustrative embodiment, the platform 110 is hosted in an economical, scalable, multi-tenant cloud facility that provides for web services, workflow development and deployment, an e-mail gateway, external system integration and reporting/analytics facilities. Such a system provides for seamless redundancy, load balancing and geographic balancing. Several application server components are deployed such as an end user interface to handle end user mail piece recipient access to the system such as through PC browser based interface through the Internet or other appropriate network. Document content injectors and content processing systems are deployed. A process server 120 is deployed for executing system functionality.

The Recipient Mailbox framework and related data such as sender and recipient preference profile storage, document event storage and document metadata storage are provided for in memory storage 160. Secure document storage 130 is provided to store the received mail piece content documents such as PDF format documents received from mailers and PDF format documents scanned and uploaded by the user. Here, the mail piece content documents are encrypted using a symmetric key as described herein and the symmetric key is encrypted using a PKI key and stored in the cloud platform associated with the mail piece. Moreover, document metadata includes metadata associated with physically mailed mail pieces that are not necessarily stored in the electronic secure document storage 130.

As described herein, metadata for physically mailed documents may be stored and displayed/manipulated by the user/recipient. In such situations, a document identifier is assigned to a mail piece that is physically mailed and the identifier is used to store and retrieve cryptographically secured metadata from data store 160 for display and manipulation in the system. Here, the SMG obtains a symmetric key assigned to the physical document even though the document is not electronically delivered. Then, the SMG will encrypt the metadata using the unique symmetric key assigned to the physical document. The asymmetric keys may be unique per instance of the system or globally unique or otherwise unique to provide sufficient security.

If the user later elects to upload a scan of the mail piece, the system may allow the user to associate the scan with the previously input document identifier. For example, a user with system ID=99 could have a paper document ID for an uploaded document of P000000099000001 and an electronic document ID for a delivered document of E000000099000001, where the letters P and E distinguish paper from electronic and 99 is the customer number. Additionally a multiple digit document type filed can be added such as 0001 for bills resulting in P0000000990001000001 for a document identifier P(USER)(TYPE)(DOC). Alternatively UUID schemes may be used. If the user selects both (B) digital and physical delivery, the document identifier would be B0000000990001000001.

Several illustrative gateways 140 are implemented in the cloud system including an identity verification gateway 142 that is used to verify the identity of system users/mail piece recipients. Additionally, address and location services gateways 144 are provided. A payment services/ecommerce gateway is provided to process bill payment and ecommerce activity such as catalog orders and promotional offer redemption activity. Certain cryptography functions may be implemented outside of the cloud system, so a cryptography services gateway 146 is provided. The internetworking connections may be secured using standard security processes and the documents and metadata/profiles may be encrypted.

In certain embodiments, a digital mailbox will be created for every individual living at every delivery point in the targeted geography of the DMP system. In such cases, the Digital Mail Platform provides an alternative delivery channel for items including mail, transaction statements, direct mail and catalogues by consolidating mail for consumers based on street address of the recipients. In such an illustrative embodiment, the Digital Mail Platform has at least 3 major systems and several subsystems interfacing to other products/systems for value added services. In a consumer mashup system, each consumer associate with street address and receive communications aggregated at address based digital mailboxes. The core platform system establishes digital mailboxes and associate the content received from mailers & publishers to consumers and provide additional value added services. The Secure Mailer Gateway creates content for digital mailboxes with required metadata and security. System will split and send e-Delivery of mail that has been opted in for e-Delivery.

Consumers are able to access their mail from different web/e-mail/mobile clients digitally with security and content certification. The Digital Mailbox will help consumers manage their life better and should offer features beyond just mail management. The Digital Mail Platform provides an ecosystem which is secure, economical and competitive for high volume mailers, postal carriers and consumers. The illustrative systems described herein may facilitate large scale systems to accommodate mail traffic consistent with country-wide activity or even larger regional or global traffic. The U.S. population is over 300 million people. Additionally, the number of valid physical street addresses in the U.S. postal system is greater than 110 million addresses. It is possible that a Digital Mail Platform could handle mail segment volumes including Potential Transaction statements of 1 Billion pieces/year and Potential Direct Mail of 2 Billion pieces/year, or more. Each digitized document might average 200 Kbytes or more using one or more formats. Such as system may support 2 Million concurrent users and may support very fast response time for various user requests such 2 seconds for login and 1 second to view a mail piece.

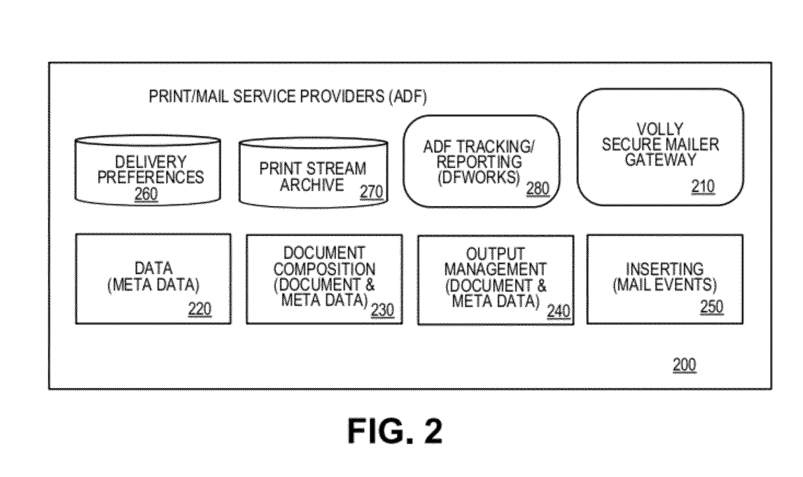

Referring to FIG. 2, a schematic diagram showing an automated document factory (ADF) 200 for providing secure mail information according to an illustrative embodiment of the present application is disclosed. Here, the ADF 200 may be implemented at a large company mail center, an outsourced mail center and/or an aggregate mail processing center. Recipient delivery preferences may be stored locally for company clients 260, may be integrated into the print stream or may be queried from an offsite data source during or shortly prior to print stream processing activities. Accordingly, when a financial institution processes a large batch of credit card statements to be sent to tens of thousands of recipients, they may be processed by such an ADF. A print stream archive may be maintained in memory storage 270.

The DFWORKS system 260 available from Pitney Bowes Inc. of Stamford, Conn. may be utilized for ADF tracking and reporting. Metadata is stored in memory storage 220, document composition to create/add/store/manipulate metadata occurs in server 230, output management for document and metadata output (including time-sensitive data such as calendar entries) are processed by server 240. A mail event inserter process runs on server 250 to provide for targeted promotional offer insertion, etc. Finally, the VOLLY secure mailer gateway system obtains electronic delivery data from the ADF for electronic mail pieces and physical mail pieces (meta data) for delivery into the VOLLY cloud architecture in the proper format and with the appropriate security.

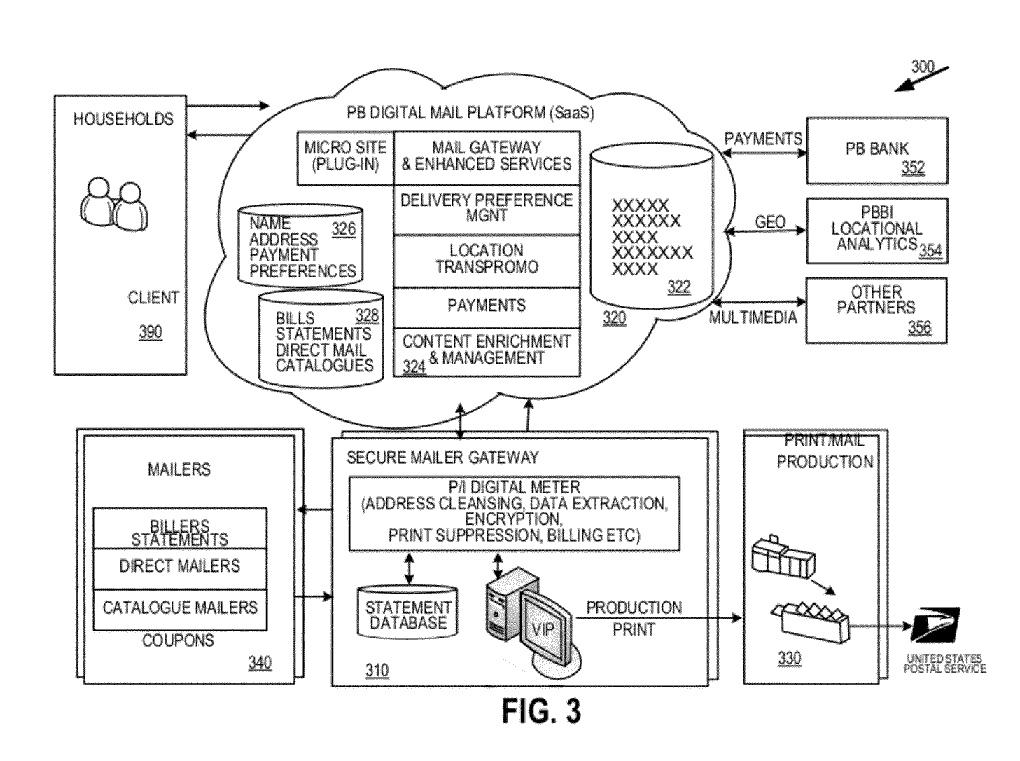

Referring to FIG. 3 is a schematic diagram showing a secure mail system 300 according to an illustrative embodiment of the present application is shown. The system 300 provides the entire ecosystem for creation/delivery and processing of mail pieces delivered electronically and physically. Here, the household client, recipients and users of the system 390 typically use a PC based browser to access the DMP through the Internet or through some other suitable connection such as a wireless connection. The many diverse mailers 340 are represented and will process bills, statements, direct promotional mail, catalogues, coupons, etc. An automated document factory includes digital processing 310 and physical processing 330.

The physical mail pieces in this illustrative embodiment are delivered by the United States Postal Service (USPS). If additional instances are provided, then additional mail piece carriers such as other national posts may be accommodated. The DMP 320 is connected to partners such as payment partners 352 for processing payments, location data partners 354 and other partners 356. Cloud processing services are hosted in cloud processing facility 324 and storage is shown at 322. Specific storage types include the individual user information with name, address and payment preferences, etc. 326 and document storage for bills, statements, direct mail and catalogues, etc. 328. Here, the user 390 may select an individual catalog from a particular sender for delivery (e.g., not any of their catalogs). When that catalog is published, it is electronically delivered to the user. Similarly, direct mail may be selected by opt-in from a sender or for a category as a first opt-in, but then require a second opt-in matching criteria such as a geographical data match of zip or city/state. Opt-in preferences and matching criteria may be stored in 326.

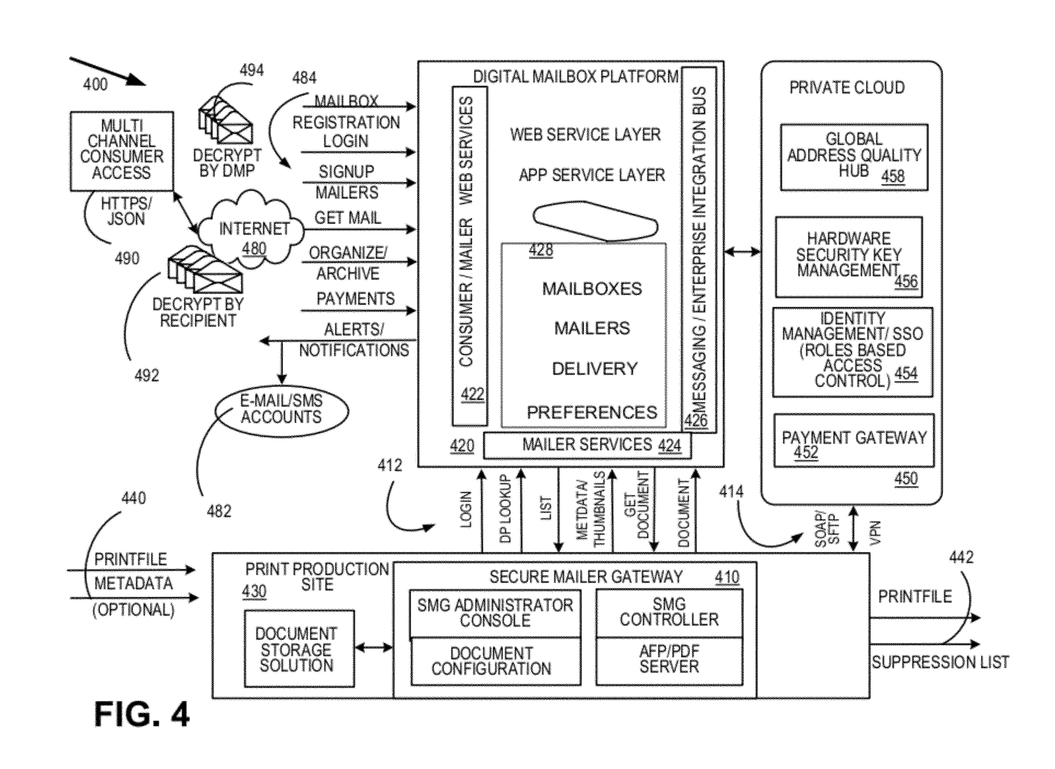

Referring to FIG. 4, a schematic diagram showing a secure mail system 400 according to an illustrative embodiment of the present application is shown. The system 400 provides the entire ecosystem for creation/delivery and processing of mail pieces delivered electronically and physically. Here, the household client, recipients and users of the system 390 typically use a PC based browser or a tablet/phone with DMP App to access the DMP through the Internet 480 or through some other suitable connection. The connection may be secured such as a secure tunnel and may use HTTPS or JSON. As described herein, the system is capable of providing different responses based upon the client type. Here, if client 490 is a tablet/phone, then the recipient client device performs the decryption of the document 492. However, if the client device 490 is a PC web browser without a DMP plug-in, then the DMP decrypts the documents 494. At least one advantage is that the user device tablet/phone has an installed app and the cryptography processing can be offloaded to the app. In most cases, this will not negatively impact the user experience. At least one advantage for the PC user is that additional plug-in software does not need to be installed or maintained.

Several communications and interaction types are shown 484. These may be directional as shown or may have communication in both direction, with sometimes primary communication direction shown. Anywhere herein, the direction arrows may indicate only part of the communication such as primary path, but could be bidirectional. The Mailbox registration, login, signup mailers, get mail, organize/archive, payments alerts/notifications by email/sms interactions are shown. However, many additional interactions are possible.

The DMP includes a server 420 that may be hosted in a so-called public cloud. The consumer/mailer web services processing functions 422 interact 484 with users 490. The mailer services processing functions 424 interact with the print production site 430. The messaging/enterprise integration bus processing functions 426 interact with the so-called private cloud 450. Here, the server provides a web service layer and an app service layer in addition to storage 428 that stores mailboxes, mailers, and delivery preferences along with other data as described herein such as metadata.

The private cloud 450 is securely connected to the DMP server 420 suh as by VPN. It includes a payment gateway 452, identity management/SSO gateway 454, hardware security key management 456 that may include a SAFENET K150 or K460, and a global address quality hub 458 that may include SPECTRUM.

The many diverse mailers 440 are represented sending printstream printfiles and optionally metadata, and will process bills, statements, direct promotional mail, catalogues, coupons, etc. An automated document factory 430 includes a secure mailer gateway 410 and will output a physical printfile for physical processing and mail suppression list 442. The private cloud is connected to the Print Production Site 430 using a VPN 414 and protocols SOAP/SFTP for transfers. The print production site 430 interacts with the DMP server 420 including interactions 412 with communications for login, DP lookup, List, Metadata/Thumbnail transfers, document transfers and get document commands.

The physical mail pieces in this illustrative embodiment are delivered by the United States Postal Service (USPS). A secure document storage system is provided that provides individual document encryption security as stored using individual keys and in certain cases provides such individual document security during transport through an encrypted communications channel tunnel. The Digital Mailbox Application (DMB) also handles document uploads into the system. These document uploads may come from the Secure Mailer Gateway (SMG), User Uploads, Scanners, direct email and other channels. The application allows various channels to securely upload the document to the server side and provide for secure decryption for the content delivery. In certain configurations, the SMG application drops the content with respective security keys for injection into the DMB application. While the primary flow of the content injection would still remain the same, respective calls would be invoked to store the keys into the key management solutions and encrypt the content. The user/scanner may directly consume the ReST services to upload documents. These documents would be visible to the user in “My Documents” section of the application. The user/scanner uploaded document will have to get integrated with content injection workflow.

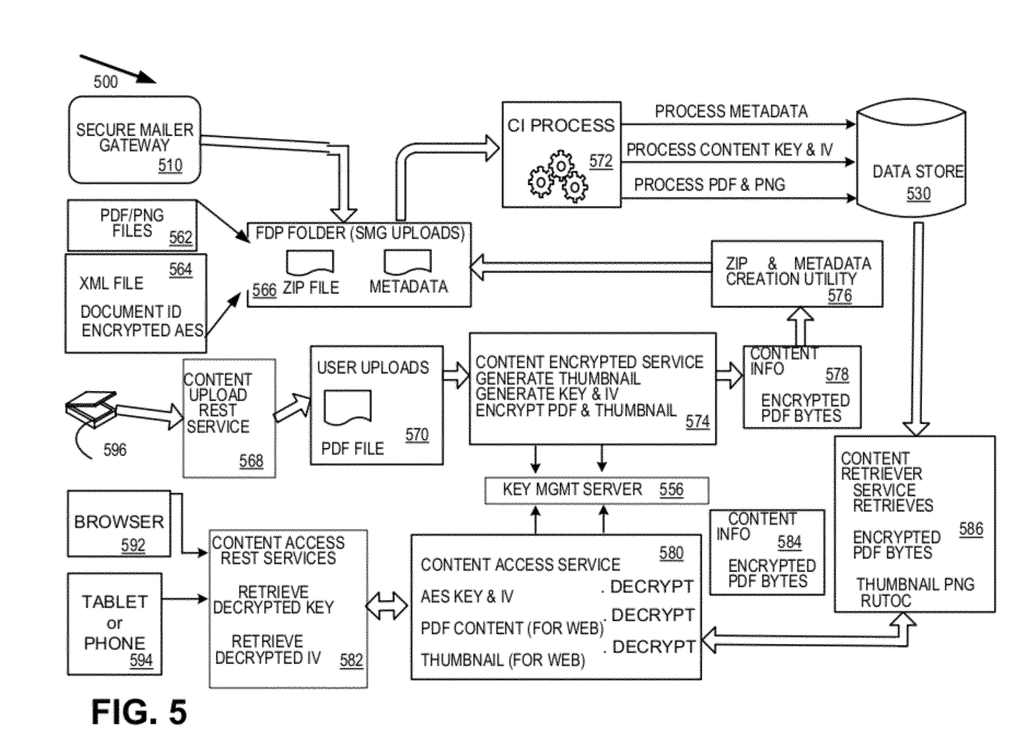

Referring to FIG. 5 is a diagram showing a data flow 500 for providing secure digital mail document storage, retrieval and use in a cloud computing environment according to an illustrative embodiment of the present application is shown.

The logical flow for user/scanner uploads permit user content insertion into the DMP system. In one step, the user/scanner 596 uploads the PDF document to the DMB application via Content Upload ReST service 568. This service 568 may accept multipart form data for large sized uploads. Then, once the document gets uploaded on the server side as a PDF in 570, a call is made to Content Encryption service 574 to perform the following: (i) Generate Thumbnail of the PDF document, (ii) Obtain/Generate a AES Key and an Initialization Vector (IV), (iii) encrypt the PDF content and the thumbnail with the Key and the IV, (iv) access the Key Management Server to access the public key, (v) encrypt the AES Key and the IV using the public key, and (vi) set the encrypted content, encrypted thumbnail, encrypted AES key and encrypted IV into an instance of Content Info object and return. The service 574 utilizes the Key Management Server 556. The Content Info object 578 gets passed to the Zip and Metadata creation utility 576 and the resulting zip and metadata 562, 564 are put into the ftp folder 566 for CI process consumption in 572.

The logical flow for Secure Mailer Gateway Uploads provides for mailer uploads. The Secure Mailer Gateway 510 uploads the Zip file and the metadata xml to the ftp folder 566 for CI process consumption in 572. The CI processes the metadata xml, then it extracts the contents of the zip file to perform the following: (i) process the xml contained within the zip file to persist the encrypted AES key and encrypted IV into the data store 530, and (ii) Process the PDF and PNG files to persist them into the data store 530.

The logic flow to get a document allows the user to obtain a document form the secure data store 530. The user requests may originate from a web page 592 or a tablet/phone (iPhone/iPad) 594 to access a document from the DMB application. The web application 592 requests the content from the RetrieveDecryptedContent ReST service 582, with the following flow. The RetrieveDecryptedContent ReST service makes a call to Content Access Service 580 for getting decrypted content 584. The Content Access Service accesses the encrypted content, encrypted thumbnail, encrypted AES key and encrypted IV 586 from the backend data store 530. The Content Access Service, accesses the private key from the key management server to decrypt the AES key and the IV, (iv) the decrypted AES key and IV are then used to decrypt the content, (v) the decrypted content is base64 encoded and returned to the calling web page.

The iPad/iPhone 592 makes successive calls to multiple services to get the decrypted Key, decrypted IV and encrypted Content. These calls may be further optimized by wrapping this information into a single data object and having a single service call. The iPhone/iPad gives a call the RetrieveDecryptedKey ReST service. This would result into the following flow: the ReST service gives a call to Content Access Service to get the decrypted key, the Content Access Service makes a call to Key Management server to retrieve the private key, the encrypted AES key is decrypted with the private key and returned to the device.

The flow for getting decrypted IV is same as that of getting the decrypted key from the backend services. The iPhone/iPad makes a request to get the encrypted content. The request is passed to the backend services to retrieve the content from the backend data store. The iPhone/iPad uses client-side crypto api to decrypt the encrypted content using the decrypted key and decrypted IV.

Alternatively, a data object to transfer the response as a json or as an xml to the calling device containing all the required information with a single call is utilized.

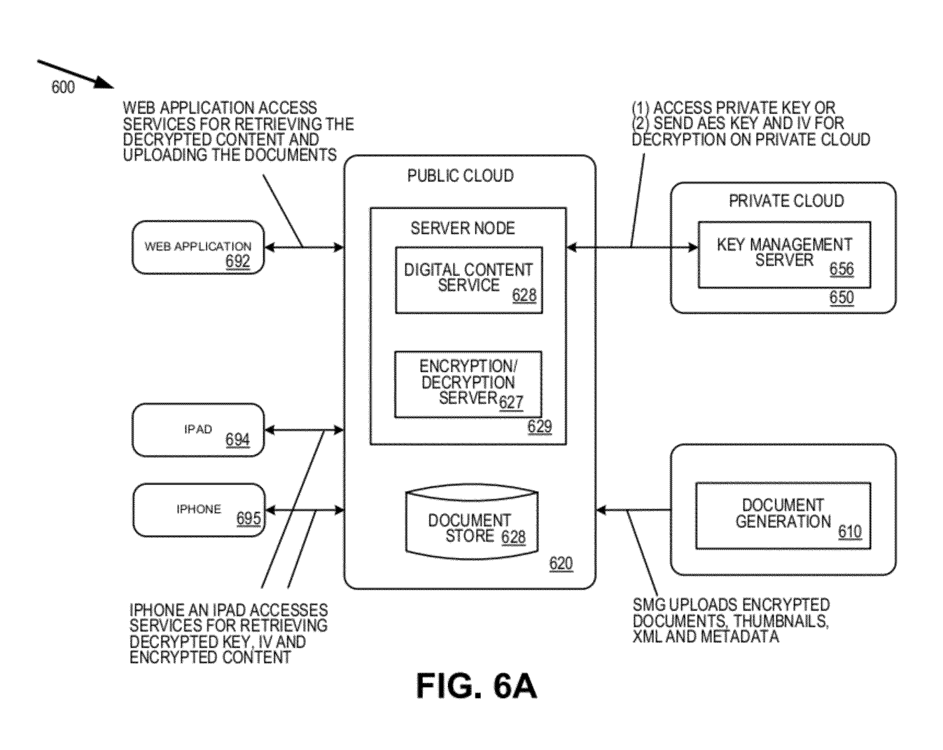

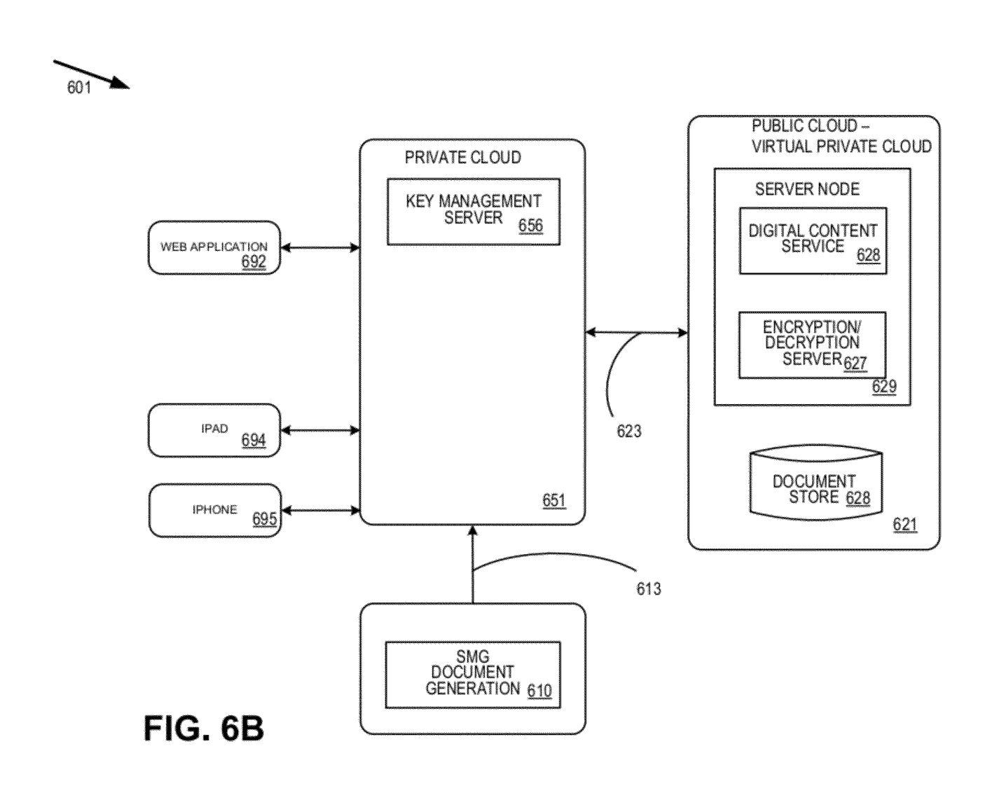

Referring to FIG. 6A, a schematic diagram showing a secure mail system 600 according to an illustrative embodiment of the present application is shown. In this alternative, used with any embodiment herein as applicable, a private cloud 650 is used to provide a key management server 656 and to (1) access a private key and or send an AES key and IV for decryption on the private cloud. The SMG 610 communicates with the public cloud 620 using a secure bidirectional channel such as through a VPN. The SMG uploads encrypted documents, thumbnails, XML and METADATA.

The client devices may include PB based web browsers or applications 692, tablets such as the IPAD 694 and smartphones such as the IPHONE 695, all securely connected to the cloud 620 such as thorough SSL tunnels. The web application accesses services for retrieving the decrypted content and uploading the documents. The tablet/phone accesses services for retrieving a decrypted key, IV and encrypted content. The tablet/phone then uses that information to decrypt the content.

Here, the public cloud 620 includes the document store 628 that securely stores documents such as mail documents as discussed herein. The server node 629 includes a digital content service 628 and an encryption/decryption server 627.

In one illustrative embodiment, a system for cryptographically securing a plurality of digital documents including a first data processing system that is privately hosted, the first data processing system including at least one private key and a PKI decryption subsystem, a second data processing system that is in a public shared hosted environment, the first data processing system including a symmetric key decryption subsystem, and memory storage for storing each of the plurality of digital documents and a corresponding symmetric key, wherein each of the plurality of digital documents is encrypted by the corresponding symmetric key and each of the corresponding symmetric key is encrypted by a public key corresponding to the at least one private key, the second data processing system including a second virtual processor and memory for executing instructions including, sending the encrypted symmetric key to the first data processing system using a secure communications channel, and the first data processing system including a first processor and memory for executing instructions including, decrypting the symmetric key using the at least one private key and returning the decrypted symmetric key to the second data processing system.

In an alternative embodiment, the first data processing system includes a private cloud computer processing system, and the second data processing system includes a public cloud computer processing system. In another alternative embodiment, the second processing system memory storage further stores a corresponding thumbnail for each of the plurality of digital documents and wherein each thumbnail is also encrypted by the corresponding symmetric key associated with the corresponding digital document.

In yet another alternative embodiment, the system further includes the second data processing system including a second virtual processor and memory for executing further instructions including, decrypting a corresponding one of the plurality of digital documents using the returned decrypted symmetric key.

In yet another alternative, the at least one private key includes at least two private keys, and the system further includes the first data processing system including a first processor and memory for executing further instructions including, determining an appropriate one private key of the at least two private keys, and decrypting the symmetric key using the appropriate one private key. In yet another alternative, determining an appropriate one private key of the at least two private keys includes utilizing a geographic identifier. In yet another alternative, the geographic identifier includes an Internet Protocol (IP) address associated with the second data processing system.

In yet another alternative, determining an appropriate one private key of the at least two private keys includes utilizing a mail carrier identifier associated with the digital document. In yet another alternative, the second data processing system communicates only with the first data processing system.

Referring to FIG. 6B, a schematic diagram showing a secure mail system 601 according to an illustrative embodiment of the present application is shown. In this embodiment, applicable as an alternative in any of the embodiments described herein, a private cloud 651 is used to control communication with the public cloud 621 such as through a single or multiple controlled communications channel 623. The SMG 610 communicates with the private cloud 651 using secure bidirectional channel 613 such as through a VPN. The client devices may include PB based web browsers or applications 692, tablets such as the IPAD 694 and smartphones such as the IPHONE 695, all securely connected to the private cloud such as thorough SSL tunnels. Here, the public cloud 621 includes the document store 628 that securely stores documents such as mail documents as discussed herein. The server node 629 includes a digital content service 628 and an encryption/decryption server 627.

The private cloud 651 is a PCI compliant and SAS 70 Certified environment that ensures that all data is secure. Application data is stored only in the private cloud and no application data is ever stored in the public cloud. The data store installed in the private cloud further masks or encrypts any fields related to PCI or HIPAA compliance. Here, the public cloud 621 is being used as a virtual private cloud with no external interface being exposed to the outside world. To safeguard the DMP service from intrusion from within the public cloud, the internal network interfaces of the machine instances in the public cloud are also secured for point-to-point access only. This helps ensure that no intruder from within the cloud can access any DMP public cloud instance. While the data is being transferred to the public cloud it cannot be accessed because of the closed point-to-point network. Moreover, all the privacy/security fields are encrypted/masked for enhanced security. The cloud orchestration framework, responsible for managing and auto-scaling the cloud infrastructure, is itself deployed in a secure private cloud with all system configurations being stored in a secure LDAP store.

In this embodiment, the private cloud 651 is a closed network, as previously mentioned, and all public access by consumers happens through the private cloud. Strong firewall support in the private cloud helps ensure a secure and safe environment. The public cloud itself is secured and closed using strong iptables based firewall strategies. The public cloud is never exposed, and all the calls from and to the public cloud go through the secure private cloud. Thus, the combined implementation of iptables, secure system configuration, effective closed-load balancing and secure proxy being used for IP and port control caters to all the security aspects required for network security.

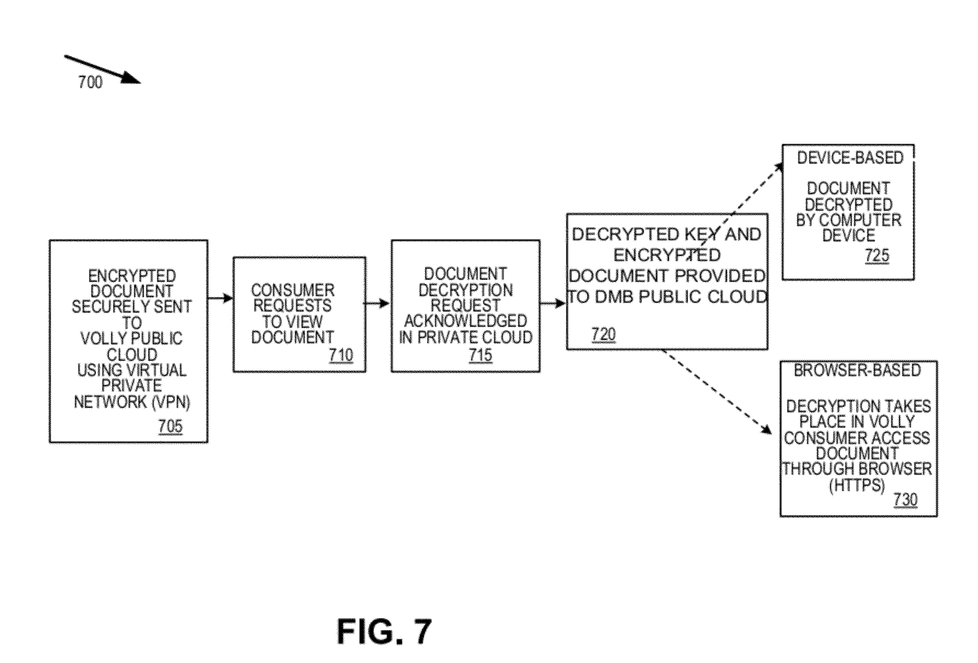

Referring to FIG. 7, a flowchart diagram showing a process 700 for decrypting secure mail documents based upon client type according to an illustrative embodiment of the present application is shown. In step 705, an encrypted document is securely sent to the DMP public cloud using a VPN. In step 710, the customer requests the document to be viewed on the client device. In step 715, the document decryption request is acknowledged in the private cloud. In step 720, the decrypted key and encrypted document are sent to the DMP public cloud. If the client is device based, such as a tablet/phone or PC heavy client, then the document is decrypted by the computer device instep 725. If the client is browser only based, then decryption takes place in DMP and the consumer accesses the document through the browser and HTTPS tunnel in step 730.

In one illustrative embodiment, a computer implemented method for processing a request from a client for a secure digital document based upon client type, the secure digital documented encrypted by a first key and the first key encrypted by a second key, the method includes determining a type of client making the request, and if the determined type of client is a first type, then decrypting the second key and sending the decrypted second key and the encrypted digital document to the client, and if the determined type of client is a second type, different from the first type, then decrypting the second key, decrypting the first key using the second key, decrypting the digital document using the first key and sending the decrypted digital document to the client.

In an alternative method, the digital document includes a digital mail piece and a thumbnail. In another alternative method, the first type is selected from a group consisting of a mobile application, a heavy client and a browser with a plug-in associated with the process. In yet another alternative method, the second type is a browser without a plug-in associated with the process. In yet another alternative, the first key is a symmetric key. In yet another alternative, the second key is an asymmetric key.

In another alternative method, the method further includes if the determined type of client is the first type, then responding to the request using a first virtual machine, and if the determined type of client is the second type, then responding to the request using a second type of virtual machine, different from the first virtual machine.

In another alternative, the second key is selected from one of a group of asymmetric keys. In yet another alternative, the second key using geographic data. In another alternative, the second key is associated with a carrier associated with the digital document.

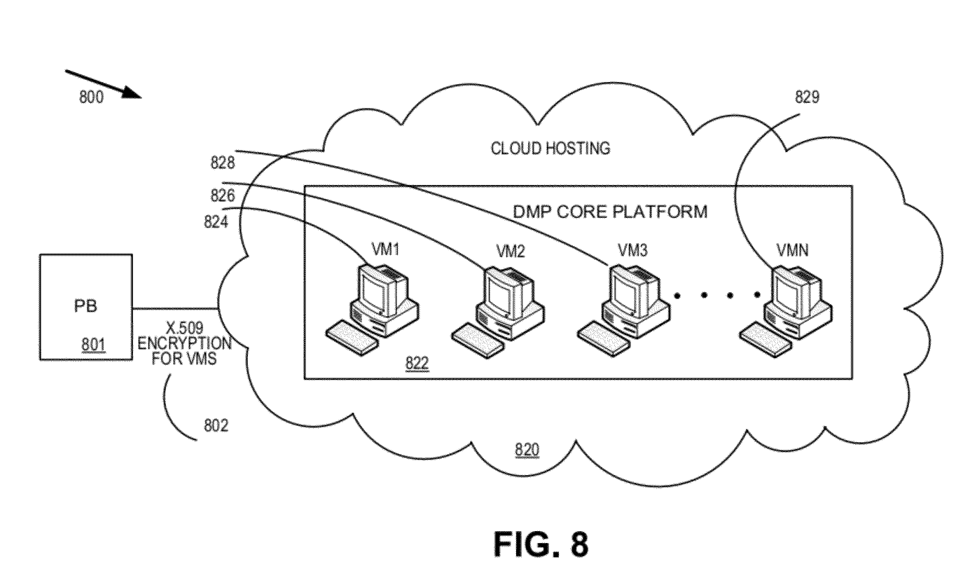

Referring to FIG. 8, a schematic diagram showing a cloud platform 800 for use in a mail system according to an illustrative embodiment of the present application is shown. In one embodiment, each of the virtual machines used in the DMP core platform in the cloud 820 are cryptographically secured such as by X.509 processing 802 for program code owner PB 801. Here, the virtual machines VM1 824, VM2 826, VM3 828 and VMn 829 are cryptographically protected. Other protection mechanisms such as monitoring and logging may be used.

In another alternative, applicable to any of the embodiments herein, unless not applicable, there are at least two different virtual machine code images VM1 824 and VM2 826 to perform a similar task such as providing access to a requested secure document. One of the virtual machine types, for example VM1 824, is more secure and uses more resources to provide security features such as monitoring and logging. The at least one other type VM2 826 is less secure and more efficient by not using such security resources. Here, the decision of which virtual machine to assign to a session is made based upon the type of device that is requesting the session. For example, if the session is started by a PC browser only client, the requested document is decrypted in the cloud. Here, the higher security virtual machine VM1 824 will be used. However, if the session is started by a tablet/phone App, the document is not decrypted in the cloud and passes to the device in its encrypted form. In such a case, the more efficient virtual machine VM2 826 will be used.

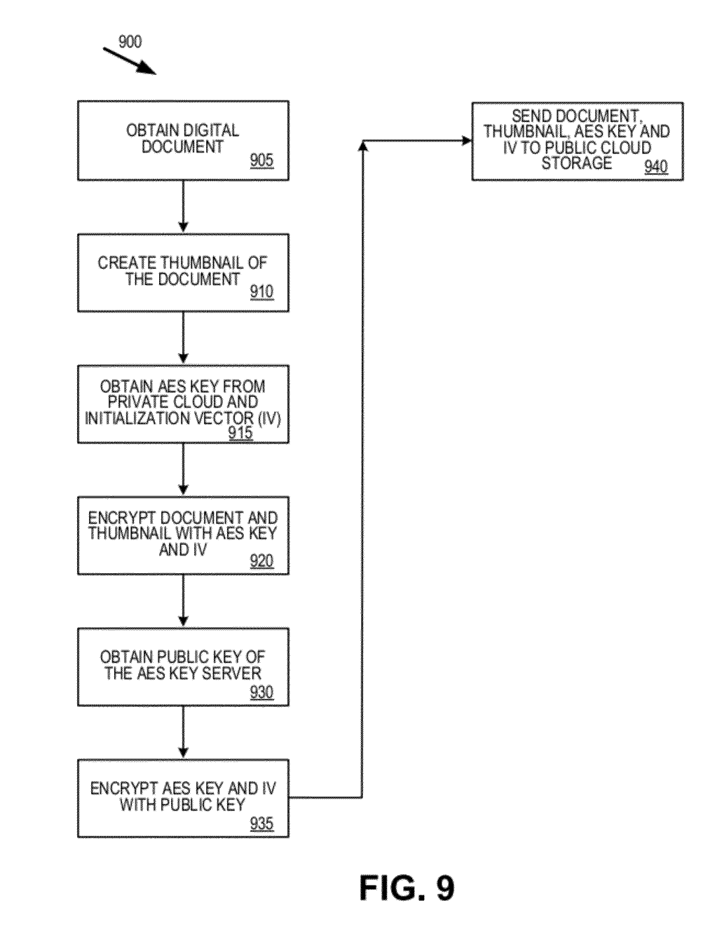

Referring to FIG. 9, a flowchart diagram showing a process 900 for encrypting secure mail documents according to an illustrative embodiment of the present application is shown. In step 905, the system obtains a digital document, such as a digital mail piece being delivered to a digital mailbox. In step 910, the system creates a thumbnail of the document. In step 915, the system obtains an AES key from the private cloud and an initialization vector (IV). In step 920, the system encrypts the digital document and thumbnail using the AES Key and the IV. In step 930, the system obtains the public key of the AES key server. In step 935, the system encrypts the AES key and the IV using the public key. In step 940, the system sends the document, thumbnail, AES key and IV to the public cloud storage such as through a VPN.

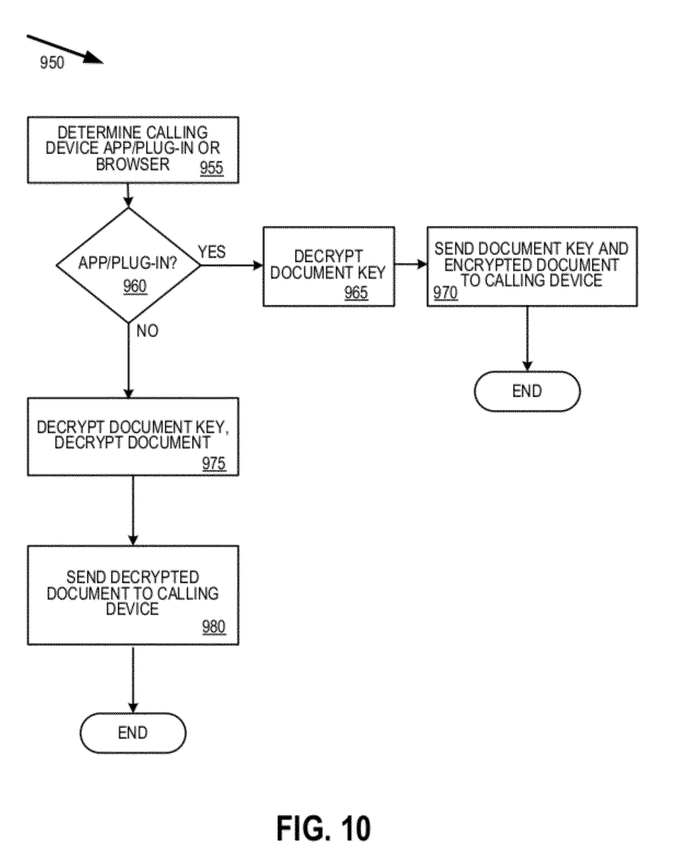

Referring to FIG. 10, a flowchart diagram showing a process 950 for decrypting secure mail documents based upon client type according to an illustrative embodiment of the present application is shown. In step 955, the system determines the calling device type such as a app/plug-in based device or a browser only device. In step 960, the system determines if the client device type is an app/plug-in type. If so, the system proceeds to step 965 to decrypt the document key and then to step 970 to send the document key and encrypted document to the calling device. If the device type is not an ap/plug-in, the system proceeds to step 975 to decrypt the document key and decrypt the document. The process then proceeds to step 980 to send the decrypted document to the calling device.

In one illustrative embodiment, a computer program system being executed on a data processing and secure storage system for processing a plurality of digitized items from a plurality of mailers associated with a digital mailbox and a user, the data processing system executing instructions including, creating a cryptographic key for each of the plurality of digitized items, encrypting each of the digitized items to create an encrypted digitized item, encrypting each of the respective cryptographic keys using one of at least one system public keys and associated each of the respective cryptographic keys with the respective digitized item, and storing each of the respective encrypted cryptographic keys and the encrypted digitized items in the secure storage system.

In the described embodiments, illustrative user client devices 390 may include a desktop personal computer, a laptop personal computer, a tablet personal computer, smartphone and/or PDA or the like. They may be connected to the Internet using a wired connection, a wireless LAN connection and/or wireless WAN/cellular or other suitable alternative. Each of the user client devices is a DELL desktop, laptop or tablet respectively and executes a WINDOWS 7 operating system and an INTERNET EXPLORER browser or a MOTOROLA device such as a DROID 3 or XYBOARD executing the ANDROID operating system or APPLE IPAD or IPHONE executing the iOS operating system. Each client device includes at least one processor, display, input such as a keyboard and mouse, RAM memory for data and instructions, disk memory, network and external storage connections.

If the above mentioned cloud architectures are not used, the server may include a DELL POWEREDGE M1000E server, but other servers may be used including geographically dispersed and/or load balanced servers. Such servers include at least one processor, RAM memory for data and instructions, disk memory, network and external storage connections. Alternatively, an IBM POWER 795 Server or APACHE Web Server may be utilized. Here, the Internet is utilized for many of the network connections of the systems 100/300, but other networks including LAN, WAN, cellular, satellite and other wired and/or wired networks may be used for one or more of the interconnections shown. The databases storing user login information and user account information may be configured using an available relational database such as ORACLE 12i or MICROSOFT SQL server or APACHE CASSANDRA. Any or all of the databases may be resident in a single server or may be geographically distributed and/or load balanced. They may be retrieved in real time or near real time using networking such as web services connected to third party data providers. Many alternative configurations may be used including multiple servers and databases including a geographically distributed system. The processes described herein may be implemented in C++, Java, C# on a MICROSOFT WINDOWS 7 platform and utilize the ADOBE CQ5 web content management system. Alternatively, PHP code may be used with open source systems and APACHE web server with APACHE CASSNDRA databases. Other alternatives such as the JOOMLA content management system and MYSQL databases may be utilized.

Typical mailers include organizations that create and deliver transactional and periodic physical communications that are often sent by first class mail such organizations including utilities, financial institutions, marketers and government agencies. Such mailers have IT systems that include recipient databases and IT systems used to provide print streams such as legacy mainframe systems that provide print stream data for statements, etc. that may be printed in the native format or reformatted and enhanced before printing. Alternatively, a Mailer may own and operate system.

In certain illustrative embodiments, the system receives a single print stream from a mailer and uses recipient profile data received from the mailer or otherwise obtained from the user to split the print stream into physical and electronic delivery streams. The Physical Distribution subsystem (printing/mailing of hard copy) is implemented in the illustrative embodiment as an automated document factory (ADF) using mail piece creation systems described may be obtained from Pitney Bowes Inc. of Stamford, Conn. that include the PITNEY BOWES SERIES 11 inserter systems, the PITNEY BOWES INTELLIJET printing system, and the PITNEY BOWES DM INFINITY postage meter. The documents produced may include the full range of documents processed in ADFs including direct mail, statements such as monthly or financial transaction statements of accounts, credit cards and brokerage accounts and may also include bills for services and utilities and goods purchased. The physical mail is then delivered to a physical mailbox for the household 70 and accessed by a member of the household.

In alternatives, the Digital Distribution subsystem may be implemented as a combination of email push systems and World Wide Web hosted electronic messaging pull systems. E-messaging system available from the Pitney Bowes Business Insights group may be built into the server.

Additionally, certain redundant communications processing systems have been described. Commonly-owned, co-pending U.S. patent application Ser. No. 12/650,751, entitled System and Method for Providing Redundant Customer Communications Delivery Using Hybrid Delivery Channels, filed by Sagi, et al. on Dec. 31, 2009 describes such systems and is incorporated by reference herein in its entirety. Such systems described therein may be modified using the systems, processes and techniques described herein.

Furthermore, certain print stream processing systems have been described for serving multiple mail recipients in a household. Commonly-owned, co-pending U.S. patent application Ser. No. 12/651,324, entitled System and Method for Electronic Delivery of Mail, filed by Sagi, et al. on Dec. 31, 2009 describes such systems and is incorporated by reference herein in its entirety. Such systems described therein may be modified using the systems, processes and techniques described herein.

Any of the alternatives described herein may be combined and/or interchanged with embodiments and alternatives including individual components thereof as appropriate.

Although the invention has been described with respect to particular illustrative embodiments thereof, it will be understood by those skilled in the art that the foregoing and various other changes, omissions and deviations in the form and detail thereof may be made without departing from the scope of this invention.

What is claimed is:

1. A system for cryptographically securing a plurality of digital documents comprising:
a first data processing system that is privately hosted, the first data processing system including at least one private key and a PKI decryption subsystem,
a second data processing system that is in a public shared hosted environment, the second data processing system including a symmetric key decryption subsystem, and memory storage for storing each of the plurality of digital documents and a corresponding symmetric key for each of said digital documents, wherein each of the plurality of digital documents is encrypted by the corresponding symmetric key and each of the corresponding symmetric key is encrypted by a public key corresponding to the at least one private key,
the second data processing system including a second virtual processor and memory for executing instructions including, sending the encrypted symmetric key to the first data processing system using a secure communications channel, and
the first data processing system including a first processor and memory for executing instructions including, decrypting the symmetric key using the at least one private key and returning the decrypted symmetric key to the second data processing system.

2. The system of claim 1, wherein,
the first data processing system includes a private cloud computer processing system, and
the second data processing system includes a public cloud computer processing system.

3. The system of claim 2, wherein,
the second processing system memory storage further stores a corresponding thumbnail for each of the plurality of digital documents and wherein each thumbnail is also encrypted by the corresponding symmetric key associated with the corresponding digital document.

4. The system of claim 1, further comprising:
the second data processing system including a second virtual processor and memory for executing further instructions including, decrypting a corresponding one of the plurality of digital documents using the returned decrypted symmetric key.

5. The system of claim 1, wherein the at least one private key includes at least two private keys, further comprising:
the first data processing system including a first processor and memory for executing further instructions including, determining an appropriate one private key of the at least two private keys,
and decrypting the symmetric key using the appropriate one private key.

6. The system of claim 5, wherein,
determining an appropriate one private key of the at least two private keys includes utilizing a geographic identifier.

7. The system of claim 6, wherein,
the geographic identifier includes an Internet Protocol (IP) address associated with the second data processing system.

8. The system of claim 5, wherein,
determining an appropriate one private key of the at least two private keys includes utilizing a mail carrier identifier associated with the digital document.

9. The system of claim 1, wherein,
the second data processing system communicates only with the first data processing system.

10. A computer program system being executed on a data processing and secure storage system for processing a plurality of digitized items from a plurality of mailers associated with a digital mailbox and a user comprising:
the data processing system executing instructions including,
creating a cryptographic key for each of the plurality of digitized items,
encrypting each of the digitized items to create an encrypted digitized item,
encrypting each of the respective cryptographic keys using one of at least one system public keys and associating each of the respective cryptographic keys with the respective digitized item, and
storing each of the respective encrypted cryptographic keys and the encrypted digitized items in the secure storage system.

11. A computer implemented method for processing a request from a client for a secure digital document based upon client type, the secure digital document encrypted by a first key and the first key encrypted by a second key to form a first encrypted key, the first encrypted key decrypted by a third key, the method comprising:
determining a type of client making the request;
if the determined type of client is a first type, decrypting the encrypted first key using the third key and sending the decrypted first key and the encrypted digital document to the client, and
if the determined type of client is a second type, different from the first type, decrypting the first encrypted key using the third key, decrypting the digital document using the first key and sending the decrypted digital document to the client.

12. The method of claim 11, wherein:
the digital document includes a digital mail piece and a thumbnail.

13. The method of claim 11, wherein:
the first type is selected from a group consisting of a mobile application, a heavy client and a browser with a plug-in.

14. The method of claim 11, wherein:
the second type is a browser without a plug-in.

15. The method of claim 11, wherein:
the first key is a symmetric key.

16. The method of claim 15, wherein:
the second key is a public key of an asymmetric key pair.

17. The method of claim 11, further comprising:
if the determined type of client is the first type, then responding to the request using a first virtual machine, and
if the determined type of client is the second type, then responding to the request using a second type of virtual machine, different from the first virtual machine.

18. The method of claim 11, wherein:
the third key is selected from one of a group of keys.

19. The method of claim 11, wherein:
the second key is selected using geographic data.

20. The method of claim 11, wherein:
the second key is associated with a carrier associated with the digital document.

21. The method of claim 11, wherein:
the second and third keys are the public and private key, respectively, of an asymmetric key pair.

22. The method of claim 11, wherein:
the second and third keys are the same.
